(19) United States
(12) Patent Application Publication
(10) Pub. No.: US 2025/0333361 A1
(43) Pub. Date: Oct. 30, 2025

(54) HIGH TEMPERATURE COATINGS

(71) Applicant: Honeywell International Inc., Charlotte, NC (US)

(72) Inventors: Mehrad Mehr, Morristown, NJ (US); Bahram Jadidian, Watchung, NJ (US)

(21) Appl. No.: 18/650,901

(22) Filed: Apr. 30, 2024

(51) Int. Cl. C04B 37/00; C09J 5/06; C09J 11/04; C09J 133/04

(52) U.S. Cl. CPC C04B 37/003; C09J 5/06; C09J 11/04; C09J 133/04; C04B 2237/062; C04B 2237/343; C09J 2433/00

(57) ABSTRACT

A method for forming a high temperature coating includes depositing a coating mixture on at least one ceramic substrate. The coating mixture includes rare earth disilicate particles and cordierite particles dispersed in a carrier medium. A weight ratio of the rare earth disilicate particles to the cordierite particles is in a range from about 50:1 to about 20:1. The method further includes heating the coating mixture above a sintering temperature of the cordierite particles to form the high temperature coating. The high temperature coating comprises the rare earth disilicate particles dispersed in a eutectic amorphous phase formed from the cordierite particles and the rare earth disilicate.

### GOVERNMENT RIGHTS

This invention was made with Government support under Grant Contract Number 80MSFC21CA010 awarded by National Aeronautics and Space Administration (NASA). The Government has certain rights in the invention.

### TECHNICAL FIELD

The disclosure relates to high temperature coatings.

### BACKGROUND

Ceramics and ceramic composites may be used in high temperature applications. For example, the space industry employs ceramic components with low coefficients of thermal expansion to form reactor vessels or piping.

### SUMMARY

The disclosure describes systems and techniques for forming a high temperature coating that includes a composition of a rare earth disilicate and cordierite. Rare earth disilicate particles including the rare earth disilicate are dispersed in a eutectic amorphous phase to form a high temperature coating having low porosity and high thermal stability. To form a coating mixture, a slurry of the rare earth disilicate particles and cordierite particles are dispersed in a carrier medium. The coating mixture is applied to a surface of a component, such as a reactor component, and the coating mixture is heated to remove the carrier medium and sinter the cordierite particles to form the eutectic amorphous phase. A weight ratio of the rare earth disilicate particles to the cordierite particles may be relatively high, such that the resulting high temperature coating includes a small proportion of the eutectic amorphous phase between the rare earth disilicate particles. Such high temperature coatings may be particularly suitable for components that are subject to a high temperature processing environment, such as a methane pyrolysis reactor having temperatures between about 500 degrees Celsius (° C.) and about 1300° C.

In one example, a method includes depositing a coating mixture on at least one ceramic substrate. The coating mixture includes rare earth disilicate particles including a rare earth disilicate and cordierite particles dispersed in a carrier medium. A weight ratio of the rare earth disilicate particles to the cordierite particles is in a range from about 50:1 to about 20:1. The method further includes heating the coating mixture above a eutectic temperature of the cordierite particles to form the high temperature coating. The high temperature coating includes the rare earth disilicate particles dispersed in a eutectic amorphous phase formed from the cordierite particles and the rare earth disilicate.

In another example, an article includes a substrate and a coating overlying the substrate. The coating includes rare earth disilicate particles including a rare earth disilicate dispersed in a eutectic amorphous phase formed from cordierite particles and the rare earth disilicate. A weight ratio of the rare earth disilicate particles to the eutectic amorphous phase is in a range from about 50:1 to about 20:1.

In another example, a coating mixture for forming a high temperature coating includes a carrier medium, rare earth disilicate particles dispersed in the carrier medium, and cordierite particles dispersed in the carrier medium. A weight ratio of the rare earth disilicate particles to the cordierite particles is in a range from about 50:1 to about 20:1.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A is a cross-sectional side view diagram of a portion of an example article having a high temperature coating formed in accordance with the techniques of this disclosure.

FIG. 1B is a cross-sectional side view diagram of a portion of an example article having a high temperature coating as a bonding interface formed in accordance with the techniques of this disclosure.

FIG. 1C is a cross-sectional expanded view diagram of an example high temperature coating formed in accordance with the techniques of this disclosure.

FIG. 2 is an expanded view diagram of an example coating mixture for a high temperature coating formed in accordance with the techniques of this disclosure.

FIG. 3 is a flow diagram illustrating an example technique for forming a high temperature coating for an article in accordance with the techniques of this disclosure.

FIG. 4A is a photograph of an example article having a high temperature coating formed in accordance with the techniques of this disclosure.

FIG. 4B is a micrograph of the high temperature coating of the example article of FIG. 4A formed in accordance with the techniques of this disclosure.

FIG. 4C is a close up micrograph of the high temperature coating of the example article of FIG. 4A formed in accordance with the techniques of this disclosure.

### DETAILED DESCRIPTION

The disclosure describes articles, such as high temperature components of reactors, having a high temperature coating that includes a composite of rare earth disilicate and a eutectic amorphous phase formed from cordierite and the rare earth disilicate that seals an underlying substrate. Porous substrates used for reactor components that include such a high temperature coating may be capable of operating in relatively high temperature processing environments with reduced leakage.

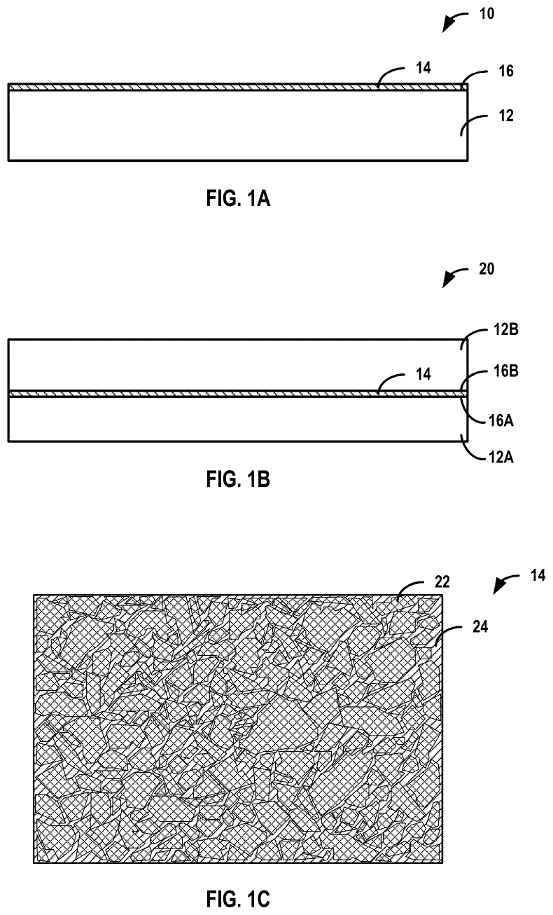

FIG. 1A is a cross-sectional side view diagram of a portion of an example article 10 including a high temperature coating 14 formed in accordance with the techniques of this disclosure. Article 10 may include any component of a high temperature thermal processing system that is configured to contain an environment having temperatures less than about 1300° C., such as components of methane pyrolysis systems.

Article 10 further includes substrate 12, and coating 14 may be formed on a surface 16 defined by substrate 12. Substrate 12 may include any ceramic material that is thermally stable at temperatures experienced in an intended high temperature application, such as temperatures between about 500° C. and about 1300° C. In some examples, substrate 12 is a ceramic matrix composite (CMC). For example, substrate 12 may include reinforcement fibers and a matrix material at least partially surrounding the reinforcement fibers. CMCs that may be used for substrate 12 include, but are not limited to, carbon/carbon, carbon/silicon carbide, silicon carbide/silicon carbide, or the like.

In some examples, substrate 12 includes cordierite at surface 16 and/or in a bulk of substrate 12. Components formed from cordierite offer a combination of thermal, mechanical, electrical, and chemical properties that make them useful in a wide range of industrial applications. Cordierite exhibits excellent thermal shock resistance, making it suitable for use in high-temperature applications where rapid temperature changes occur, such as kiln furniture, catalytic converters, and other heat-intensive processes. Cordierite also has a relatively low coefficient of thermal expansion, such that a component including cordierite maintains its shape and dimensions well over a wide range of temperatures. Cordierite can withstand high temperatures without deforming or degrading, making it suitable for use in environments with extreme heat conditions, such as automotive, aerospace, and industrial manufacturing. Cordierite is chemically inert and resistant to many corrosive substances, making it suitable for use in aggressive chemical environments, such as for catalyst supports and chemical processing equipment.

In addition to its thermal, mechanical, electrical, and/or chemical properties, at least a portion of cordierite from substrate 12 may be capable of forming the eutectic amorphous phase in coating 14, thereby promoting adhesion between substrate 12 and coating 14. For example, during formation of coating 14, a portion of the cordierite in substrate 12 may sinter and react with the rare earth disilicate particles to form a portion of coating 14.

While substrate 12 may be relatively resistant to relatively high temperatures, substrate 12 may be porous and/or be joined to another substrate, such that process gases may pass through substrate 12 and/or between substrate 12 and the other substrate if not sealed. For example, cordierite may include pores that result from manufacturing processes used to form the cordierite. Such porosity can compromise the chemical stability of cordierite in high temperature oxidative environments, as an interconnected pore network may provide pathways for oxidative agents to penetrate the material, leading to degradation over time. This degradation can be problematic in applications where chemical resistance is essential, such as in chemical processing equipment or harsh industrial environments.

To protect substrate 12 from leakage of process gases, article 10 includes high temperature coating 14 on one or more surfaces 16 of substrate 12 subject to process gases during operation. Surface 16 may include surfaces intended for contact with a thermal processing environment, and may only be a portion of substrate 12. Coating 14 may be stable at temperatures of up to a fabrication temperature of coating 14, such as about 2400° F. (about 1300° C.), such that coating 14 does not degrade into its constituent elements and/or does not react with other elements or compounds present in the environment in which coating 14 is used including, but not limited to, oxidation, for a period of time (e.g., minutes or hours). Coating 14 may have any suitable thickness. In some examples, a thickness of coating 14 may be about 25 micrometers (μm) to about 500 μm.

As will be described further in FIG. 1C below, coating 14 includes rare earth disilicate particles dispersed in a eutectic amorphous phase. Rare earth disilicate particles may form a tightly packed phase making up a high volume fraction of coating 14. A rare earth disilicate (e.g., of the rare earth disilicate particles) may provide coating 14 with thermal stability, oxidation resistance, chemical inertness, adhesion, and erosion resistance, contributing to enhanced performance, durability, and reliability of coated substrate 12 in high temperature environments. However, rare earth disilicate may not strongly adhere directly to substrate 12. For example, substrate 12 may include cordierite with substantial surface porosity and a relatively inert surface, such that substrate 12 and rare earth disilicate in coating 14 may have low compatibility.

To improve adhesion of coating 14 to substrate 12, coating 14 includes a eutectic amorphous phase that results from liquid sintering of cordierite and the rare earth disilicate. The eutectic amorphous phase may form a dense binding phase making up a low volume fraction of coating 14. The eutectic amorphous phase may be configured to adhere coating 14 to underlying substrate 12 and seal surface 16 of substrate 12. As a result, coating 14 may form a dense, shock resistant, and substantially impermeable rare earth disilicate barrier.

In some examples, high temperature coatings described herein may be positioned between two ceramic substrates as a binding interface to bind two substrates together and reduce leakage at the binding interface. FIG. 1B is a cross-sectional side view diagram of a portion of an example article 20 including a high temperature coating 14 as a bonding interface formed in accordance with the techniques of this disclosure. Article 20 includes a first ceramic substrate 12A defining a first surface 16A, a second ceramic substrate 12B defining a second surface 16B, and high temperature coating 14 positioned between first surface 16A and second surface 16B. High temperature coating 14 functions as a high temperature interface bonding ceramic substrates 12A and 12B together.

FIG. 1C is a cross-sectional expanded view diagram of an example high temperature coating 14 formed in accordance with the techniques of this disclosure. Coating 14 includes a particle-derived eutectic amorphous phase 24 and rare earth disilicate particles 22 dispersed in eutectic amorphous phase 24. Rare earth disilicate particles 22 may form a tightly packed phase making up a high volume and weight fraction of coating 14, and may provide coating 14 with a bulk of its properties related to thermal stability and shock resistance. Eutectic amorphous phase 24 may make up a low volume and weight fraction of coating 14, and may function as a binder and sealant to bind rare earth disilicate particles 22 and fill voids between rare earth disilicate particles 22.

Eutectic amorphous phase 24 may include components that result from liquid sintering cordierite in the presence of the rare earth disilicate particles, and that maintain thermal and chemical stability at high temperatures, such as up to about 1300° C. While not being limited to any particular theory, cordierite may form a eutectic system with at least one rare earth disilicate, for example, of rare earth disilicate particles 22. During formation of eutectic amorphous phase 24, the cordierite particles may be heated treated to a temperature to allow the formation of a liquid phase of cordierite and initiate a liquid phase sintering process. A liquid phase sintering temperature of cordierite may be about 1420° C., which may be substantially similar to the eutectic temperature of eutectic amorphous phase 24. Cordierite may begin to melt at the eutectic temperature, and a proportion of cordierite that is liquid may increase as a temperature rises beyond the eutectic temperature. During liquid phase sintering, a portion of the liquid phase cordierite may react with rare earth disilicate from the rare earth disilicate particles 22 to form eutectic amorphous phase 24.

Once the cordierite particles liquefy and sinter, the liquid phase cordierite may be solidified by reducing a temperature below the eutectic temperature, thereby forming a eutectic amorphous phase 24. The resulting coating 14 may include crystalline rare earth disilicate particles 22 and eutectic amorphous phase 24. In some examples, eutectic amorphous phase 24 may be present as a substantially (e.g., greater than 95% by volume) liquid phase during fabrication of coating 14. A sintering temperature of cordierite at which cordierite and the rare earth disilicate form amorphous glass phase 24 may be about 1420° C., while a melting temperature of cordierite may be about 1460° C. Eutectic amorphous phase 24 may be present in coating 14 in a distribution and volume fraction sufficient to bond rare earth disilicate particles 22 together. For example, rare earth disilicate particles 22 may form a tightly packed aggregate with small voids between particles. Eutectic amorphous phase 24 may fill these voids to secure and seal the particles.

Rare earth disilicate particles 22 maintain thermal and chemical stability at temperatures at or above about 1500° C. Rare earth disilicate particles 22 may be present as a powder that includes relatively loose particles or an aggregate that includes relatively constrained (e.g., packed) particles. Various parameters of the particles, such as particle size, particle shape, and particle size distribution of rare earth disilicate particles 22 may be selected such that rare earth disilicate particles 22, once bonded in eutectic amorphous phase 24, forms a tightly packed, mechanically robust material. In some examples, rare earth disilicate particles 22 may have an average diameter from about 1 micrometer to about 100 micrometers. A variety of rare earth disilicates may be used including, but not limited to, yttrium disilicate, ytterbium disilicate, neodymium disilicate, lanthanum disilicate, and the like.

In some examples, coating 14 may include more than one particle composition of rare earth disilicate particles 22. Various properties of coating 14, such as effective coefficient of thermal expansion, may result from a combination of properties of rare earth disilicate particles 22 and eutectic amorphous phase 24. In some examples, rare earth disilicate particles 22 may be part of a mix of more than one species, such that coating 14 may have properties resulting from a blend of rare earth disilicate particles 22. For example, a mix of more than one species may be configured to enhance thermal shock, by including a blend of refractory powders having different elastic moduli, thermal conductivities, and/or thermal expansion coefficients to produce coating 14 having a particular bulk elastic modulus, thermal conductivity, and/or thermal expansion. In some examples, rare earth disilicate particles 22 may include active species configured to interact with other species. For example, a mix of more than one species may include a species configured to react with oxidative species, such as oxygen.

In some examples, coating 14 includes a particular weight ratio of rare earth disilicate particles 22 to eutectic amorphous phase 24. As mentioned above, the volume and/or weight ratio of rare earth disilicate particles 22 to eutectic amorphous phase 24 may be kept relatively large to maintain a high amount of the more chemically and thermally stable rare earth disilicate particles 22. In some examples, a weight ratio of rare earth disilicate particles 22 to eutectic amorphous phase 24 is in a range from about 50:1 to about 20:1.

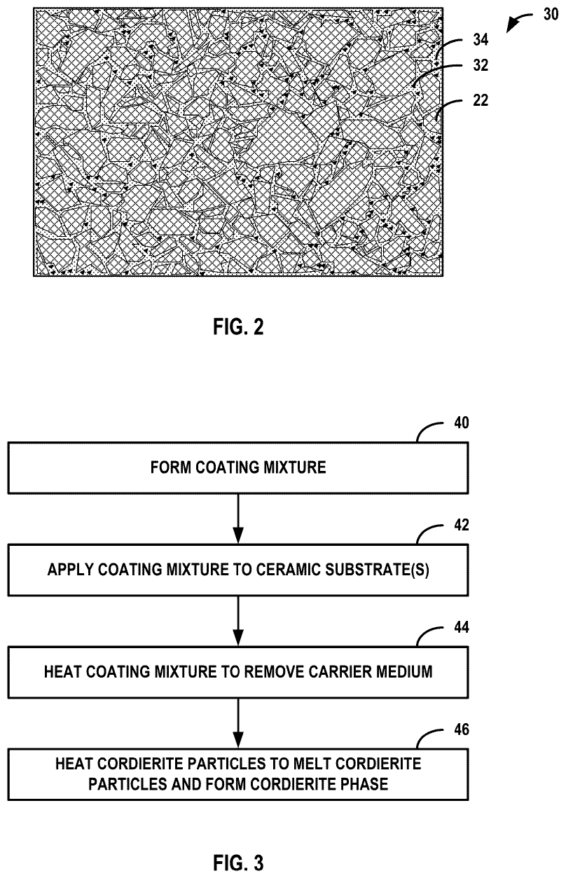

Coatings described herein, such as coating 14 of FIGS. 1A-1C are formed from a silicon-rich refractory mixture that includes a silicon carbide powder and a silicon-rich silicon carbide preceramic polymer. FIG. 2 is an expanded view diagram of an example coating mixture 30 for a high temperature coating formed in accordance with the techniques of this disclosure. Coating mixture 30 includes a liquid component 34, cordierite particles 32, and rare earth particles 22 dispersed in liquid component 34.

In some examples, a composition, particle size or shape, and/or particle size distribution of coating mixture 30 may be selected to produce a resulting coating that is relatively free of thermal defects, such as cracking caused by changes in temperature during crystallization of cordierite from cordierite particles 32. In some examples, a relative composition of rare earth disilicate particles 22 to cordierite particles 32 may be selected for a desired relative composition of rare earth disilicate particles 22 to eutectic amorphous phase 24 in a resulting coating 14. For example, a weight ratio of rare earth disilicate particles 22 to cordierite particles 32 is in a range from about 50:1 to about 20:1.

In some examples, rare earth disilicate particles 22 are configured with a particular average particle size or shape and/or a particle size distribution of rare earth disilicate particles 22 within eutectic amorphous phase 24. A density of coating 14 may be related to a compaction or packing density of rare earth disilicate particles 22. To increase the density of coating 14 and enhance its properties, a coating mixture used to form coating 14 may include an extended distribution of particle sizes, such as a bimodal or trimodal distribution of particle sizes. A bimodal or trimodal particle size distribution may be configured to form a highly packed refractory material and increase the overall density of the materials and performance. The particle size distribution may vary based on a composition of rare earth disilicate particles 22 and volume ratio of rare earth disilicate particles 22 to eutectic amorphous phase 24; this distribution may determine packing. In some examples, a packing factor may be at least about 60% by volume, such as from about 60% to about 75%, depending on particle size distribution. “About” a particular packing factor may be within 10% of the value, such as within 5% or 1%, and may refer to an accuracy and capability of equipment used to measure the packing factor and/or control of manufacture of particles size and/or particle size distribution.

Prior to heating, rare earth disilicate particles 22 may be densely packed, such that grains of rare earth disilicate particles 22 contact grains of adjacent particles. During removal of the carrier medium, small voids may form between cordierite particles 32 and rare earth disilicate particles 22 due to removal of the carrier medium, such that the dried coating may have a higher porosity and lower density. During sintering of cordierite particles, sintered cordierite may migrate into these voids, creating a higher density eutectic amorphous phase 24 upon cooling and crystallization. In this way, by tightly packing cordierite particles 32 and rare earth disilicate particles 22, a resulting coating, such as coating 14, may have a high density and enhanced mechanical properties.

In some examples, cordierite particles 32 may have a particle size distribution configured to improve packing of rare earth disilicate particles in coating mixture 30. Cordierite particles 32 may include both large cordierite particles and small cordierite particles. Large cordierite particles may have an average diameter between about 1 and about 2 micrometers, while small cordierite particles may have an average diameter between about 20 and about 50 nanometers. A relative distribution of large cordierite particles to small cordierite particles may be selected to improve the packing density. In some examples, a weight ratio of the large cordierite particles to the small cordierite particles is in a range from about 60:40 to about 80:20.

In some examples, coating mixture 30 may be configured to be applied as a paste that is subsequently heated. The paste may be formed into a coating having a predetermined thickness corresponding to a desired thickness of the final coating. As such, coating mixture 30 may have various flow properties related to an ability of coating mixture 30 to flow or move onto surface of the substrate and/or various adhesion properties related to an ability of coating mixture 30 to form a relatively uniform and conforming coating after application. As one example, for a substrate with relatively complex features, coating mixture 30 may have a relatively low viscosity, such that coating mixture 30 may be applied to the surface of the substrate and flow onto portions of the surface having the relatively complex features. On the other hand, for a substrate with relatively simple features, coating mixture 30 may have a relatively high viscosity corresponding to a lower volume fraction of liquid component 34, thereby reducing an amount of the preceramic polymer.

In some examples, coating mixture 30 may have a particular ratio of liquid component 34 to cordierite particles 32 and rare earth disilicate particles 22. The ratio of liquid component 34 to cordierite particles 32 and rare earth disilicate particles 22 may be related to a number of flow or adhesion properties of coating mixture 30, such as viscosity and/or dispersibility. For example, the ratio of liquid component 34 to cordierite particles 32 and rare earth disilicate particles 22 may be sufficiently high that cordierite particles 32 and rare earth disilicate particles 22 may be evenly distributed throughout coating mixture 30; sufficiently high that coating mixture 30 may flow onto a surface or into a mold; and/or sufficiently low that coating mixture 30 may maintain a uniform coating after application and prior to sintering of cordierite particles 32. In some examples, coating mixture 30 has a volume ratio of liquid component 34 to rare earth disilicate particles 22 and cordierite particles 32 that is less than or equal to about 1:5. In some examples, rare earth disilicate particles 22 and cordierite particles 32 are present in coating mixture 30 in a composition greater than about 70 weight percent, such as greater than or equal to about 80 weight percent.

In some examples, liquid component 34 includes a carrier medium. The carrier medium may be configured to maintain a flowability of coating mixture 30 and be removed from a coating formed from coating mixture 30 upon heating. A variety of carrier media may be used including, but not limited to, organic solvents, such as terpineol; oils; and the like. In some examples, the carrier medium may be selected for desired properties of coating mixture 30 or a coating formed from coating mixture 30. As one example, the carrier medium may be selected for fluid properties related to an ability to be applied as a paste and conform to a surface of an underlying substrate.

In some examples, the carrier medium is configured to aid in application of a coating formed from coating mixture 30. For example, the carrier medium may aid in flowing coating mixture 30 in a desired thickness and with a desired conformance prior to sintering of cordierite particles 32. The carrier medium may wet surfaces of cordierite particles 32, surfaces of rare earth disilicate particles 22, and surfaces of an underlying substrate, such as substrate 12 of FIGS. 1A-1C. As a result, the coating formed from cordierite particles 32 and rare earth disilicate particles 22 may be continuous and substantially uniform. In some examples, the carrier medium in coating mixture 30 is present in a concentration by weight between about 3 wt. % and about 30 wt. %.

In some examples, liquid component 34 includes other materials configured to aid in formation of a coating. In some examples, liquid component 34 includes an acrylic binder. The acrylic binder may be configured to improve adhesion and cohesion of a resulting coating. For example, an acrylic binders may be a polymer that forms a film when dried, thereby holding together cordierite particles 32 and rare earth disilicate particles 22 prior to sintering of cordierite particles 32 and aiding to adhere the resulting coating to an underlying substrate. Additionally, acrylic binders may contribute to other properties of the intermediate coating prior to being burned off, such as flexibility, durability, and adhesion, and may improve the flow and leveling of coating mixture 30 during application, resulting in a smoother and more uniform coating surface. Acrylic binders that may be used include, but are not limited to, acrylic emulsions, styrene-acrylic copolymers, acrylic resins, and the like.

In some examples, liquid component 34 includes a surfactant. The surfactant may be configured to act as a wetting agent and dispersing agent in coating mixture 30. For example, surfactants may reduce a surface tension of coating mixture 30, allowing coating mixture 30 to wet surface of the underlying substrate more effectively, thereby promoting better adhesion of the coating to the substrate by ensuring proper contact between coating mixture 30 and the surface. As another example, surfactants may assist in breaking up agglomerates of cordierite particles 32 and/or rare earth disilicate particles 22 in coating mixture 30, thereby improving the uniformity of the coating by preventing clumping and ensuring a homogeneous distribution of particles. A variety of surfactants may be used including, but not limited to, nonionic surfactants, anionic surfactants, cationic surfactants, amphoteric surfactants, and the like.

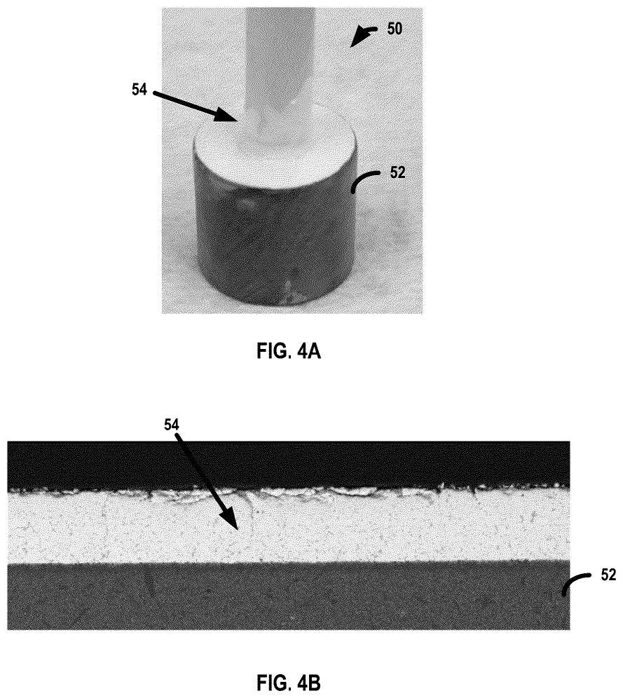

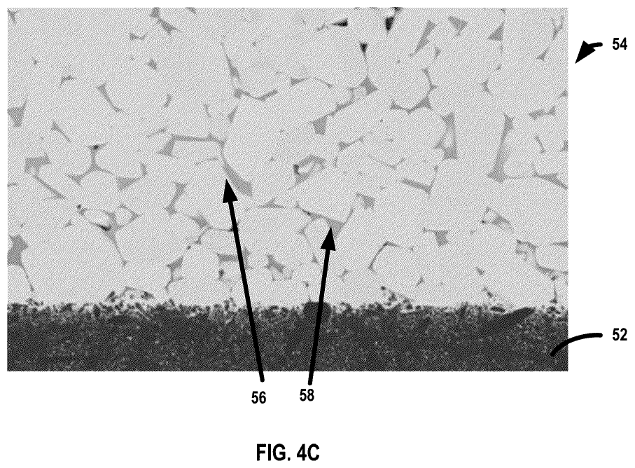

FIG. 3 is a flow diagram illustrating an example technique for forming a high temperature coating for an article in accordance with the techniques of this disclosure. FIG. 4 will be described with respect to coating 14 of FIGS. 1A-1C and coating mixture 30 of FIG. 2 as applied to article 10 of FIG. 1A and/or article 20 of FIG. 1B.

The method includes forming a coating mixture (40), such as coating mixture 30 of FIG. 2. Coating mixture 30 includes cordierite particles 32 and rare earth disilicate particles 22 in liquid component 34. Coating mixture 30 may be formed by at least mixing cordierite particles 32, rare earth disilicate particles 22, and any solvents and/or dispersants. A weight ratio of rare earth disilicate particles 22 to cordierite particles 32 may be in a range from about 50:1 to about 20:1. In some examples, cordierite particles 32 include large cordierite particles having an average diameter from about 1 to about 2 micrometers, and small cordierite particles having an average diameter from about 20 to about 50 nanometers. A weight ratio of the large cordierite particles to the small cordierite particles may be selected in a range from about 60:40 to about 80:20.

Coating mixture 30 may include a proportion of a solvent sufficient to substantially mix coating mixture 30 into a well-dispersed mixture, and may depend on the particular composition of particles and method of mixing. In some examples, cordierite particles 32 and rare earth disilicate particles 22 are present in a composition greater than about 70 weight percent of coating mixture 30. In some examples, the solvent is present at a concentration greater than about 5 percent by volume, such as from about 5 percent by volume to about 30 percent by volume. In some examples, a proportion of solvent in coating mixture 30 may be modified to tailor the viscosity of coating mixture 30. For example, an amount of solvent ideal for evenly mixing coating mixture 30 may be different from an amount of solvent ideal for dispersing coating mixture 30 on a surface of a substrate. As such, an amount of solvent may be added or removed to provide a desired consistency of coating mixture 30 prior to forming a coating.

The method further includes applying coating mixture 30 on a ceramic substrate, such as on surface 16 of substrate 12 in FIG. 1A or one or both of surfaces 16A and/or 16B of respective substrates 12A and/or 12B in FIG. 1B (42). For example, coating mixture 30 may be applied, such as by painting, spraying, painting, dipping, or other deposition method, to one or more surfaces of a component of an aerospace system that may encounter a high temperature oxidative environment.

The method includes heating the coating mixture to remove the carrier medium or other solvent in the liquid component (44). For example, coating mixture 30 may be heated above a temperature at which the carrier medium is removed but lower than a sintering temperature of cordierite particles 32.

The method includes heating the coating to sinter the cordierite particles and form a eutectic amorphous phase, such as sintering cordierite particles 32 to form eutectic amorphous phase 24 (46). The coating of coating mixture 30 may be heated to a heat treatment temperature in an inert atmosphere or under vacuum. The heat treatment temperature is sufficiently high, such as above a sintering temperature of cordierite (e.g., 1400° C.), to sinter cordierite particles 32 of the coating and consolidate the cordierite into a substantially continuous eutectic amorphous 24. In some examples, the heat treatment temperature may be below a melting temperature of cordierite to reduce exposure of articles 10 or 20 to high temperatures. This eutectic amorphous phase 24 may extend into pores or other voids left by removal of the carrier medium. The resulting coating 14 includes rare earth disilicate particles 22 in a dense eutectic amorphous phase 24.

In some examples, the method includes applying additional layers of coating 14. For example, steps 42, 44, and 46 may be repeated with coating mixture 30 to apply additional layers on top of existing layers. In some examples, step 40 may be repeated with a coating mixture having a different composition than the coating mixture of underlying layers of coating 14.

FIG. 4A is a photograph of an example article 50 having a high temperature coating 54 formed in accordance with the techniques of this disclosure, while FIG. 4B is a micrograph of high temperature coating 54 of the example article 50 of FIG. 4A formed in accordance with the techniques of this disclosure. High temperature coating 54 overlies a surface of a cordierite substrate 52. Coating 54 was formed from a coating mixture having large cordierite particles with an average size of 1 to 2 micrometers and small cordierite particles with an average size of 20 to 50 nanometers formed from attrition milling. Cordierite particles were added to rare earth disilicate particles at 2 to 5 weight percent. The cordierite particles and rare earth disilicate particles where mixed with acrylic binders, surfactant and terpineol to form a high solid loading ceramic past with solid loadings of about 80 weight percent. The paste was applied to cordierite substrate 52, dried in an oven, and fired to temperatures of about 1400° C.

FIG. 4C is a close up micrograph of high temperature coating 54 of the example article 50 of FIG. 4A formed in accordance with the techniques of this disclosure. High temperature coating includes rare earth disilicate particles 56 dispersed in a eutectic amorphous phase 58. A weight ratio of rare earth disilicate particles 56 to eutectic amorphous phase 58 is in a range from about 50:1 to about 20:1.

Various examples have been described. These and other examples are within the scope of the following claims.

What is claimed is:

1. A method for forming a high temperature coating, the method comprising:
depositing a coating mixture on a surface of at least one ceramic substrate, wherein the coating mixture comprises rare earth disilicate particles comprising a rare earth disilicate and cordierite particles dispersed in a liquid component, and wherein a weight ratio of the rare earth disilicate particles to the cordierite particles is in a range from about 50:1 to about 20:1; and
heating the coating mixture above a eutectic temperature of the cordierite particles to form the high temperature coating, wherein the high temperature coating comprises the rare earth disilicate particles dispersed in a eutectic amorphous phase formed from the cordierite particles and the rare earth disilicate.

2. The method of claim 1,
wherein the at least one ceramic substrate comprises two ceramic substrates, and
wherein the high temperature coating comprises a high temperature interface bonding the two ceramic substrates.

3. The method of claim 1, wherein the rare earth disilicate particles and the cordierite particles are present in a composition greater than about 70 weight percent of the coating mixture.

4. The method of claim 1,
wherein the cordierite particles comprise:
large cordierite particles having an average diameter from about 1 to about 2 micrometers; and
small cordierite particles having an average diameter from about 20 to about 50 nanometers, and
wherein a weight ratio of the large cordierite particles to the small cordierite particles is in a range from about 60:40 to about 80:20.

5. The method of claim 1, wherein the liquid component comprises:
an acrylic binder;
a surfactant; and
a carrier medium that includes terpineol.

6. The method of claim 1, wherein the surface of the at least one ceramic substrate comprises cordierite.

7. The method of claim 1, wherein the rare earth disilicate particles have an average diameter from about 1 micrometer to about 100 micrometers.

8. The method of claim 1, wherein the method further comprises, prior to heating the coating mixture above a sintering temperature of the cordierite particles, heating the liquid component to remove a carrier medium of the liquid component.

9. The method of claim 1, wherein heating the coating mixture includes heating the coating mixture above the sintering temperature and below a melting temperature of the cordierite particles.

10. The method of claim 1, wherein the at least one ceramic substrate comprises a component of an aerospace system.

11. An article, comprising:
at least one ceramic substrate; and
a high temperature coating overlying a surface of the at least one ceramic substrate, wherein the high temperature coating comprises rare earth disilicate particles comprising a rare earth disilicate dispersed in a eutectic amorphous phase formed from cordierite particles and the rare earth disilicate particles,
wherein a weight ratio of the rare earth disilicate particles to the eutectic amorphous phase is in a range from about 50:1 to about 20:1.

12. The article of claim 11,
wherein the at least one ceramic substrate comprises two ceramic substrates, and
wherein the high temperature coating comprises a high temperature interface bonding the two ceramic substrates.

13. The article of claim 11, wherein the surface of the at least one ceramic substrate comprises cordierite.

14. The article of claim 11, wherein the rare earth disilicate particles have an average diameter from about 1 micrometer to about 100 micrometers.

15. The article of claim 11, wherein the substrate comprises a component of an aerospace system.

16. A coating mixture for forming a high temperature coating, comprising:
a liquid component comprising a carrier medium;
rare earth disilicate particles dispersed in the carrier medium; and
cordierite particles dispersed in the carrier medium,
wherein a weight ratio of the rare earth disilicate particles to the cordierite particles is in a range from about 50:1 to about 20:1.

17. The coating mixture of claim 16, wherein the rare earth disilicate particles and the cordierite particles are present in a composition greater than about 70 weight percent of the coating mixture.

18. The coating mixture of claim 16,
wherein the cordierite particles comprise:
large cordierite particles having an average diameter between about 1 and about 2 micrometers; and
small cordierite particles having an average diameter between about 20 and about 50 nanometers, and
wherein a weight ratio of the large cordierite particles to the small cordierite particles is in a range from about 60:40 to about 80:20.

19. The coating mixture of claim 16, wherein the liquid component comprises:
an acrylic binder;
a surfactant; and
a carrier medium that includes terpineol.

20. The coating mixture of claim 16, wherein the rare earth disilicate particles have an average diameter from about 1 micrometer to about 100 micrometers.
